(19) United States
(12) Patent Application Publication
(10) Pub. No.: US 2004/0208129 A1
(43) Pub. Date: Oct. 21, 2004

(54) Testing network communications

(75) Inventors: Gordon Old, Edinburgh (GB); Colin Johnstone, Inverkeithing (GB)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 10/762,157

(22) Filed: Jan. 21, 2004

(30) Foreign Application Priority Data
Apr. 17, 2003 (GB) 0308871.3

(51) Int. Cl. H04L 12/26

(52) U.S. Cl. 370/241

(57) ABSTRACT

For testing communication in a network which carries data frames between communications ports having respective addresses, each frame containing an indication of the address of the source of the frame, the address of the intended destination of the frame, and other data, a tester has at least one communications port and a receiver for receiving a data frame arriving at the communications port. The tester includes circuitry for recognising test data frames according to at least one predetermined criterion, and extracting predetermined items from each test data frame including the source and destination addresses. A new test data frame is generated incorporating the predetermined items, with the source and destination addresses exchanged, and incorporating additional content of predetermined value, and a transmitter transmits the new data frame with the exchanged addresses into the network.

### TECHNICAL FIELD

This invention relates to methods and apparatus for testing communication in a network, for example Ethernet tributary data streams which are merged for transmission over SONET or SDH (Synchronous Digital Hierarchy) networks.

### BACKGROUND ART

Recent years have seen a continuing increase world-wide in the volume of data-related (as distinct from voice-related) telecommunications traffic traversing communications networks. Various approaches are available to accommodate this expanding demand for communications bandwidth. One is to build entirely new networks designed specifically to handle large volumes of data. However, this is not a good economic solution for operators with existing large installed networks which must continue to operated to maximise revenue. Another approach is to install a new packet data network (e.g. using Internet Protocol—IP—or Ethernet or a combination of them), to replace the existing high-capacity SONET/SDH systems used for transmission of voice traffic. To ensure continued service for voice traffic this requires installation of the packet network in relatively large sections which can then be substituted for sections of the SONET/SDH network, so a large initial capital outlay is required.

A third option is to use existing SONET/SDH networks to carry payload comprising packet data, collected and distributed for example via tributary data streams implemented using Ethernet technology. This involves a smaller capital outlay, continues to generate (or even increase) revenue from existing network installations, and does not affect continuity of service for existing customers whose traffic is carried over the SONET/SDH network.

However, installation, testing and maintenance of such composite systems pose new challenges. To allow round-trip measurements in an IP network, a stream of special test frames is typically generated. Because IP and Ethernet Media Access Control (MAC) frames have source and destination addresses, it is not possible simply to re-send a frame from the far (receiving) end back to the near (originating) end without changing the frame (known as passive loop-back). As a minimum, a new frame must be created from the received frame by exchanging the source and destination addresses for both MAC and IP (source for destination and vice-versa). This change in turn forces recalculation of the MAC Frame Check Sequence (FCS), as this value is calculated from the payload data including the node addresses. Other changes may be desirable, such as resetting the IP ‘time-to-live’ parameter.

Thus some apparatus must be involved at the receiving end which can receive, interpret, change, reassemble and retransmit frames. Owing to the nature of IP, there may be other traffic present on the networks being tested. In most cases this other traffic should not be looped back, so the receiving apparatus must also be able to recognize special test frames and filter them before modification and retransmission. Data packet retransmission devices can use either bit-forwarding or store-and-forward. In bit-forwarding only a few bytes are stored by the device before frame retransmission is begun, so it is usual for retransmission of a frame to be started even before it has been fully received. In store-and-forward the whole packet is received by the device before re-transmission occurs. Store-and-forward typically requires more memory than bit-forwarding.

If bit forwarding is used, it is possible for packet retransmission to begin before a filter is activated to cancel frame retransmission. In this case the retransmitting apparatus would be creating aborted frames, with possible detrimental effects on the network equipment. It may also have an effect on the performance of the path to be measured because of the additional, though false, traffic created. In true store-and-forward the entire frame is stored in the apparatus before retransmission begins, requiring additional costly data storage.

### DISCLOSURE OF INVENTION

According to one aspect of this invention there is provided a tester for testing communication in a network that carries data frames between communications ports having respective addresses, each frame containing an indication of the address of the source of the frame, the address of the intended destination of the frame, and other data, comprising:

at least one communications port;

a receiver for receiving a data frame arriving at the communications port;

circuitry for

recognising test data frames according to at least one predetermined criterion and extracting predetermined items from each test data frame, including the source and destination addresses, and

generating a new test data frame incorporating the predetermined items, with the source and destination addresses exchanged, and incorporating additional content of predetermined value; and

a transmitter for transmitting the new data frame with the exchanged addresses into the network.

According to another aspect of this invention there is provided a method of testing communication in a network that carries data frames between communications ports having respective addresses, each frame containing an indication of the address of the source of the frame, the address of the intended destination of the frame, and other data, comprising the steps of:

providing at least one communications port;

receiving a data frame arriving at the communications port;

recognising test data frames according to at least one predetermined criterion and extracting predetermined items from each test data frame, including the source and destination addresses;

generating a new test data frame incorporating the predetermined items, with the source and destination addresses exchanged, and incorporating additional content of predetermined value; and

transmitting the new data frame with the exchanged addresses into the network.

An advantage of this invention is that it neither aborts frame transmission in the manner of a bit-forwarding device, nor does it require additional memory storage as in a store-and-forward device. Nonetheless the behaviour of apparatus employing this invention closely mimics a store-and-forward device returning only the desired test packets.

### BRIEF DESCRIPTION OF DRAWINGS

A method and apparatus in accordance with this invention, for testing Ethernet equipment providing tributary links to SONET or SDH transmission systems, will now be described, by way of example, with reference to the accompanying drawings, in which:

FIG. 1 is a schematic block diagram of a SONET/SDH network with tributary data streams from Ethernet local-area networks (LANs);

FIG. 2 is a schematic block diagram of a test set for testing the network shown in FIG. 1;

FIG. 3 shows the format of an Ethernet data frame generated by the test set of FIG. 2;

FIG. 4 is a schematic diagram of two test sets as shown in FIG. 2 providing a “1-port loopback/loop-thru” mode of testing; and

FIG. 5 is a block schematic diagram of circuitry included in the test set in FIG. 4 that is operating in “loop-thru” mode.

### DETAILED DESCRIPTION

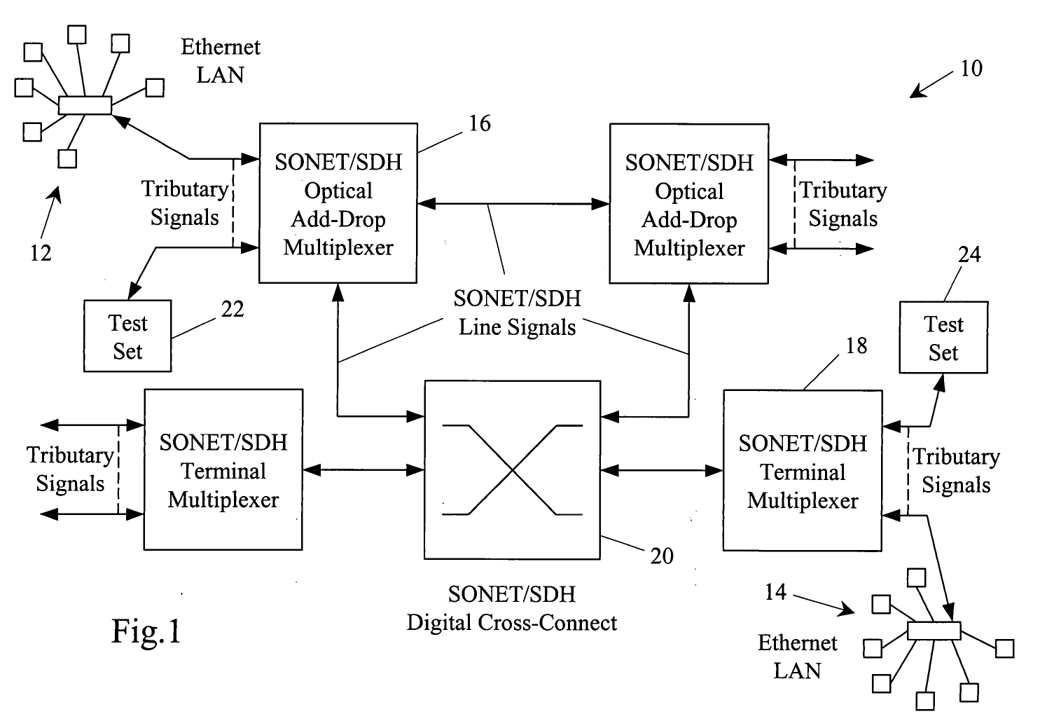

FIG. 1 shows an example of a data communications network 10 for transmitting data frames between two Ethernet LANs 12 and 14 via a transmission system 16 which uses SONET or SDH technology. Each Ethernet LAN has multiple stations or nodes (for example, workstations, file servers, print servers, printers and other appliances) connected in a star topology to one or more hubs or Ethernet switches. One of the hubs in each LAN 12 and 14 also has a connection to SONET or SDH access or aggregation equipment such as an optical add-drop multiplexer (OADM) 16 or a terminal multiplexer 18. This equipment receives tributary signals in their native formats (in the present case Ethernet frames) and either creates SONET/SDH frames by combining the tributary signals from multiple sources (terminal multiplexer) or inserts portions of a tributary signal into respective sections of the payload envelope of successive existing frames (add-drop multiplexer). The multiplexers 16 and 18 are interconnected over SONET/SDH links either directly or via digital cross-connect equipment 20. The details of SONET/SDH frame structure and of operation of equipment such as terminal multiplexers, add-drop multiplexers and cross-connects are well know to those skilled in the art and need not be discussed here.

The installation and maintenance of a system such as the network 10 shown in FIG. 1 frequently involves the transmission of test signals (Ethernet data frames) over selected paths in the network in order to confirm that the network equipment (links, multiplexers, cross-connects etc.) comprising those paths is operating correctly. For example, a test set 22 connected to the OADM 16 maybe used to inject test frames into the network 10 for transmission to another test set 24 connected to the terminal multiplexer 18. Testing of a system including Ethernet components requires specifying one or more port addresses for each Ethernet component. The addressing scheme by which data frames are routed to their intended destination over an Ethernet LAN involves the allocation to each Ethernet interface equipment (plug-in card or integral circuitry) of a globally unique 12-digit (6-byte) hexadecimal station address such as 08:00:07:A9:B2:FC.

A predefined set of Ethernet station addresses is permanently stored and used selectively in both the test sets 22 and 24 to determine the destination addresses of Ethernet frames transmitted by the test sets. These station addresses are drawn from those allocated in accordance with Ethernet practice to the manufacturer of the test sets. Typically the set of addresses is the same for all examples of the same test set model, but different for different models. Selection of particular combinations of addresses in each test set is co-ordinated by the test sets in accordance with user selection of one of several predefined test modes. In addition, to maintain full flexibility of operation the user is able to configure all Ethernet addresses and related parameters individually, to cater for circumstances where the predefined test modes are not appropriate.

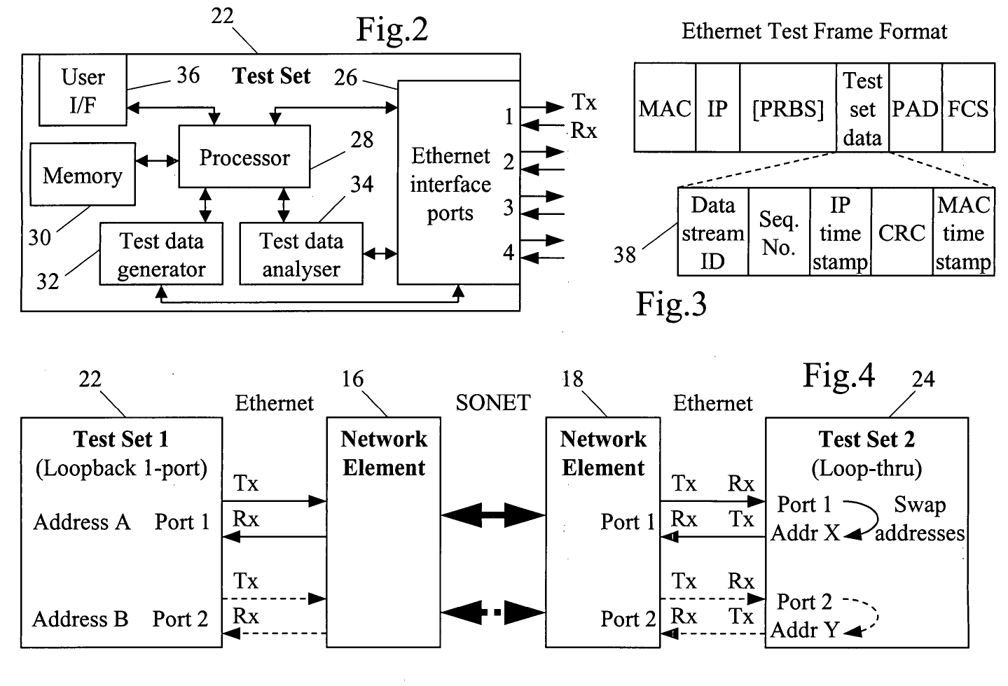

FIG. 2 shows, by way of example, the principal functionality of the test set 22 (and 24) for implementing the present invention. Referring to FIG. 2, a set of Ethernet interface ports 26 (optical or electrical, 10 Mb/s, 100 Mb/s, 1 Gb/s and/or 10 Gb/s) is provided for connection to the network elements of the network 10 such as the OADM 16 and the terminal multiplexer 18. Four interface ports are shown, but a larger number may be provided if desired. Each Ethernet interface port comprises a transmit output Tx (e.g. containing a laser in the case of an optical port) and a receive input Rx (e.g. containing a photodiode receiver). The Ethernet ports 26 are coupled to a processor 28 which co-ordinates operation of the test set 22 in accordance with software program instructions stored in a memory 30. Test data to be transmitted via the Ethernet ports 26 are generated in a test data generator 32, for example using a pseudo-random binary sequence (PRBS) generator, and assembled with appropriate Ethernet MAC headers (described below) and check data to produce Ethernet frames. Likewise test data in Ethernet frames received via the Ethernet ports 26 are extracted from the frames by a test data analyser 34, and summarised data are supplied to the processor 28. The functional requirements of the user of the test set and the results of tests performed are communicated via a user interface 36 (e.g. a display and input device such as a keyboard) controlled by the processor 28. The arrangement of functionality as shown in FIG. 2 is illustrative only, and the details of practical implementation may vary. For example, most or all of the functionality of the test data analyser 34 may be provided by software algorithms stored in the memory 30 and executed by the processor 28.

The Ethernet frames assembled by the test data generator 32 have a format shown in FIG. 3, which in most respects conforms to the format of normal Ethernet frames. Each such frame starts with Media Access Control (MAC) information, such as a preamble, start-of-frame delimiter, destination address, source address and frame length/type indicator, and IP header fields. The client data or payload (if present—see below) comprises PRBS test data generated by the test data generator 32, followed by five fields of four bytes each of test set data 38. These five fields contain:

an identifier for the test data stream of which the frame is a part, comprising the physical port number (as distinct from station address) of the Ethernet port which transmitted the frame;

a sequence number for the frame within that stream;

a field for an IP timestamp;

a cyclic redundancy check (CRC) code for the preceding values within the test set data bytes 38; and

a field for a MAC timestamp (not covered by the preceding CRC code).

Providing both IP and MAC timestamps enables allowance to be made for different latencies: the IP latency includes phenomena such as delays introduced by the MAC PAUSE mechanism, whereas the MAC latency does not. The client data are padded as necessary to the minimum specified length for an Ethernet frame, and followed by a frame check sequence (FCS) comprising a 32-bit CRC code. However, when minimal length test packets are required the length of the MAC, IP, test set data, pad and FCS fields leave no room for a PRBS, so in this case the payload is omitted. The frame format shown in FIG. 3 is referred to below as a “special test frame”. A feature of this format is that the frames can readily be filtered from other traffic that may be present on the network, for example by using the test set data CRC to detect presence of the test set data fields 38. For IP round-trip measurements the frames must of course include IP fields. However the invention is also applicable to MAC testing in which case the frames would not need to contain IP fields.

The test sets 22 and 24 provide various predefined test modes, such as Loopback (2-port), End-to-end, Loopback (1-port) and Loop-thru. Each test set stores the same overall set of Ethernet addresses which can be selectively allocated to different ones of the interface ports 26 in the test set and selectively included in Ethernet frames transmitted by different ports 26 in that or another test set. For the purposes of this description four of these addresses will be identified as Address A, Address B, Address X and Address Y.

In many test configurations one (originating) test set generates and transmits test data frames that traverse the network under test to a remote test point. There they are either received and immediately validated in a second test set, or returned by a loop-back cable or a second test set to the originating set for validation. Each test set 22 and 24 can be configured as an originating set (Test Set 1) or a receiving/loop-back set (Test Set 2). When the Test Set 1 configuration is selected, Addresses A and B are associated with the test set's ports 1 and 2; when the Test Set 2 configuration is selected, Addresses X and Y are associated with those ports.

Referring to FIG. 4, the Loopback (1-port) and Loop-thru test modes mentioned above are intended for use together, with a test set that is configured as Test Set 1 (the test set 22 in FIG. 4) in Loopback (1-port) mode, and the test set that is configured as Test Set 2 (the test set 24) being in Loop-thru mode. The destination address for Ethernet frames sent from port 1 of the test set 22 is Address X of port 1 of the test set 24. However, the test set 24 is not arranged for independent generation of its own Ethernet frames. Instead it is arranged to retransmit on the same port the frames it receives, after having exchanged or swapped the source and destination addresses they contain and recalculated and updated each frame's FCS. Thus the frames it receives have Address A as source address and Address X as destination address, and it retransmits these frames with Address X as source address and Address A as destination address. Accordingly the test set 22 receives back on port 1 the frames it has transmitted from that port.

With test sets configured in Loopback (1-port)/Loop-thru modes, a loopback test can be accomplished using just one port on each test set and with a single duplex link in the SONET/SDH network, irrespective of the specific implementation of Ethernet in use (e.g. with auto-negotiation). If desired, additional ports on the test sets 22 and 24 can be used to send additional test frames on a round trip through different paths across the network, for example between the ports 2 of the test sets as indicated in dashed line in FIG. 4.

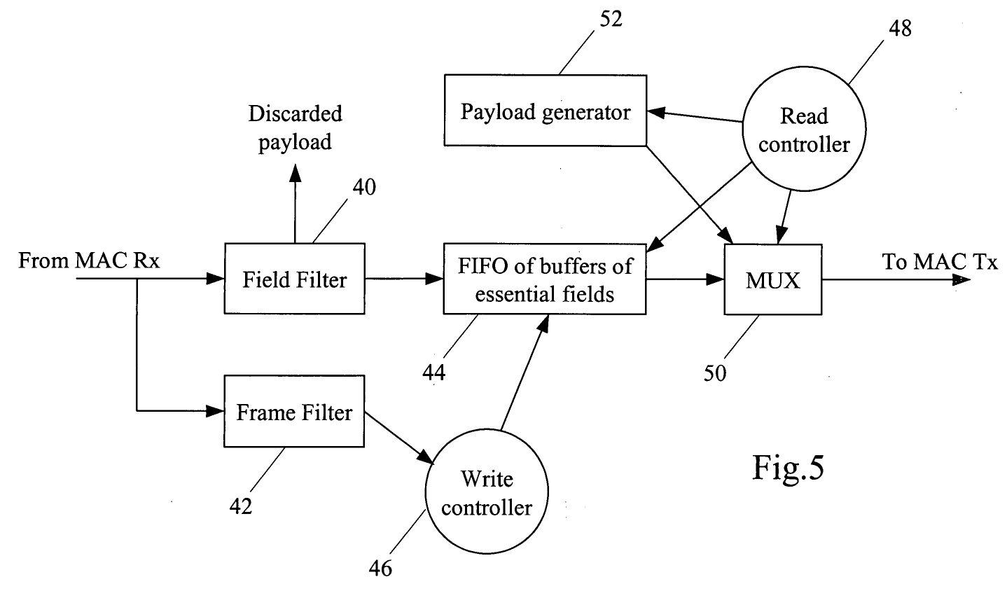

FIG. 5 shows the functional blocks incorporated in the test set 24 in one possible implementation of the present invention. This implementation is in hardware form because of speed requirements and because the latency introduced by this circuitry is deterministic, enabling accurate round-trip latency measurements. In this case round-trip testing is performed using only the special test frames described above, which can be readily filtered from other traffic. The format of these test frames is chosen so that only a few bytes of information need be extracted and processed for retransmission:

the MAC header (the source and destination addresses of which will be swapped for retransmission);

IP header (again with source and destination addresses to be swapped);

The test set data fields 38 (FIG. 3).

The remainder of the retransmitted frame can be recreated by fixed formula independently of the received data (i.e. without any significant information processing dependent on the content of the received frame and therefore very quickly):

PRBS (generated according to the standard algorithm, from an arbitrary seed value); no measurements or tests are performed on the PRBS, so there is no need to return the PRBS as received to the transmitting test set, or even to use a PRBS ‘seed’ (e.g. a fragment comprising the first n bits of the received PRBS, where n is greater than the order of the PRBS) to enable that PRBS to be regenerated;

PAD (this is all zeroes);

FCS (this is recalculated using the normal algorithm).

The fields extracted and processed amount to a small amount of data (approximately 40 bytes) per frame, whereas the fields discarded, primarily the PRBS, can be several kilobytes long. If it is desired to maintain the phase relationship between the PRBS as received and that transmitted, then a small seed fragment of the received PRBS, as described above, could be extracted and transferred to the transmit portion of the test set 24, to control generation of a new PRBS to be incorporated in the retransmitted frame. This seed would constitute a small, constant-length portion of data, facilitating design of rapid circuitry. If more flexibility of PRBS selection is desired, then both the PRBS type and a seed large enough to cater for the largest PRBS envisaged would need to transferred.

Referring to FIG. 5, a MAC receiver (MAC Rx) in the Ethernet interface ports 26 of the test set 24 supplies decoded Ethernet frames to a field filter 40 and a frame filter 42. Data from fields selected by the field filter 40, as described below, are passed to a first-in first-out (FIFO) RAM buffer 44, for storage at buffer locations under the control of a write controller 46. Each buffer location can store all of the data fields necessary to recreate a test frame. Data from the FIFO 44 is read out under the control of a read controller 48 and combined by a multiplexer (MUX) 50 with data from a payload generator 52, to generate frames that are output by a MAC transmitter (MAC Tx) in the interface ports 26.

The interface from the MAC Rx comprises a data bus carrying MAC frames, (including MAC header bytes) with associated data validity signals and other strobe signals to identify the start and end of the frame. Using these strobe signals, the field filter 40 isolates and forwards to the FIFO 44 only those fields directly required to recreate the frame for retransmission. The write controller 46 provides addressing signals to route the selected fields to the appropriate buffer location, or to disable writes and discard the frame if the FIFO 44 is full. The frame filter 42 monitors each incoming frame to determine whether or not it is a special test frame, in this example by testing whether the CRC code for the test set data fields 38 is correct (i.e. whether the received CRC value matches a CRC result calculated over the test set data fields preceding that received CRC code). If it is not a test frame the write controller 46 is arranged to respond by over-writing the same buffer location with the next incoming frame. If the frame is a special test frame then at the end of the frame the write controller 46 indicates to the read controller 48 that the contents of the buffer location are ready for retransmission, and writes the next incoming frame to the next following buffer location. In terms of practical implementation the write controller 46 may for example control some address lines of the FIFO RAM buffer 44, and the field filter 40 may control the remaining address lines.

Each special test frame includes a variable-length payload that can be created from formula (i.e. deterministically), such as a pseudo-random binary sequence (PRBS) or a “walking ones” pattern (such as 0001, 0010, 0100, 1000, 0001, 0010, . . . ). The format of a special test frame is such that the set of essential fields will be of a constant length regardless of the length of the frame, enabling the designation of fixed-size buffers in the FIFO 44 to contain the essential fields of a special test frame.

The read controller 48 responds to the indication from the write controller 46 that there is a buffer location of data ready for retransmission, by controlling the multiplexer 50 to recreate a special test frame from the data in the buffer location and from the payload generator 52.

It is in principle possible to implement a similar scheme to that described above, but with the required fields of a frame being captured and passed to software, which transfers these fields. However software is typically very much slower than hardware for such tasks, so this approach must rely on the incoming frames all sharing the same general characteristics, such as source and destination addresses. One disadvantage of this approach is that the beginning of a burst of frames will be lost, or retransmitted with the wrong fields, unless the transmitter can be preset with an expectation of the format of the incoming frames.

The example above has been described in the context of the use of Ethernet tributary streams, and the conventional terminology such as “data frame” and “station address” has accordingly been used. The invention may also be used in the context of other kinds of packet data networks, and the terminology used herein should therefore be understood to embrace also analogous concepts and features in such other kinds of networks for which alternative terminology is conventionally used (e.g. packets and network addresses instead of frames and station addresses).

1. A tester for testing communication in a network that carries data frames between communications ports having respective addresses, each frame containing an indication of the address of the source of the frame, the address of the intended destination of the frame, and other data, comprising:
at least one communications port;
a receiver for receiving a data frame arriving at the communications port;
circuitry for
recognising test data frames according to at least one predetermined criterion and extracting predetermined items from each test data frame, including the source and destination addresses, and
generating a new test data frame incorporating the predetermined items, with the source and destination addresses exchanged, and incorporating additional content of predetermined value; and
a transmitter for transmitting the new data frame with the exchanged addresses into the network.

2. The tester of claim 1, wherein the predetermined criterion comprises presence in a frame of payload data in predetermined format including a valid CRC code.

3. A method of testing communication in a network that carries data frames between communications ports having respective addresses, each frame containing an indication of the address of the source of the frame, the address of the intended destination of the frame, and other data, comprising the steps of:
providing at least one communications port;
receiving a data frame arriving at the communications port;
recognising test data frames according to at least one predetermined criterion and extracting predetermined items from each test data frame, including the source and destination addresses;
generating a new test data frame incorporating the predetermined items, with the source and destination addresses exchanged, and incorporating additional content of predetermined value; and
transmitting the new data frame with the exchanged addresses into the network.

4. The method of claim 3, wherein the predetermined criterion comprises presence in a frame of payload data in predetermined format including a valid CRC code.
